(19) United States
(12) Patent Application Publication
(10) Pub. No.: US 2011/0131154 A1
(43) Pub. Date: Jun. 2, 2011

(54) NAVIGATION DEVICE, METHOD & SYSTEM

(76) Inventors: Joost Benedictus Leonardus Faber, Zeist (NL); Rory Jones, Amsterdam (NL)

(21) Appl. No.: 12/736,850

(22) PCT Filed: Jul. 10, 2009
(86) PCT No.: PCT/EP2009/058824

§ 371 Date: Feb. 11, 2011

(30) Foreign Application Priority Data
Jan. 13, 2009 (GB) 0900479.7

(51) Int. Cl. G06F 15/16; G07B 15/02

(52) U.S. Cl. 705/418; 709/203

(57) ABSTRACT

A navigation device is arranged to communicate information to a server. In at least one embodiment, the navigation device is arranged to determine a period of time for which a vehicle carrying the navigation device is parked, and to communicate information to the server associated with the period of time.

### FIELD OF THE INVENTION

This invention relates to navigation devices and to methods for paying for services using a navigation device. Illustrative embodiments of the invention relate to portable navigation devices (so-called PNDs), in particular PNDs that include Global Positioning System (GPS) signal reception and processing functionality. Other embodiments relate, more generally, to any type of processing device that is configured to execute navigation software so as to provide route planning, and preferably also navigation, functionality.

### BACKGROUND TO THE INVENTION

Portable navigation devices (PNDs) that include GPS (Global Positioning System) signal reception and processing functionality are well known and are widely employed as in-car or other vehicle navigation systems.

In general terms, a modern PNDs comprises a processor, memory (at least one of volatile and non-volatile, and commonly both), and map data stored within said memory. The processor and memory cooperate to provide an execution environment in which a software operating system may be established, and additionally it is commonplace for one or more additional software programs to be provided to enable the functionality of the PND to be controlled, and to provide various other functions.

Typically these devices further comprise one or more input interfaces that allow a user to interact with and control the device, and one or more output interfaces by means of which information may be relayed to the user. Illustrative examples of output interfaces include a visual display and a speaker for audible output. Illustrative examples of input interfaces include one or more physical buttons to control on/off operation or other features of the device (which buttons need not necessarily be on the device itself but could be on a steering wheel if the device is built into a vehicle), and a microphone for detecting user speech. In a particularly preferred arrangement the output interface display may be configured as a touch sensitive display (by means of a touch sensitive overlay or otherwise) to additionally provide an input interface by means of which a user can operate the device by touch.

Devices of this type will also often include one or more physical connector interfaces by means of which power and optionally data signals can be transmitted to and received from the device, and optionally one or more wireless transmitters/receivers to allow communication over cellular telecommunications and other signal and data networks, for example Wi-Fi, Wi-Max GSM and the like.

PND devices of this type also include a GPS antenna by means of which satellite-broadcast signals, including location data, can be received and subsequently processed to determine a current location of the device.

The PND device may also include electronic gyroscopes and accelerometers which produce signals that can be processed to determine the current angular and linear acceleration, and in turn, and in conjunction with location information derived from the GPS signal, velocity and relative displacement of the device and thus the vehicle in which it is mounted. Typically such features are most commonly provided in in-vehicle navigation systems, but may also be provided in PND devices if it is expedient to do so.

The utility of such PNDs is manifested primarily in their ability to determine a route between a first location (typically a start or current location) and a second location (typically a destination). These locations can be input by a user of the device, by any of a wide variety of different methods, for example by postcode, street name and house number, previously stored “well known” destinations (such as famous locations, municipal locations (such as sports grounds or swimming baths) or other points of interest), and favourite or recently visited destinations.

Typically, the PND is enabled by software for computing a “best” or “optimum” route between the start and destination address locations from the map data. A “best” or “optimum” route is determined on the basis of predetermined criteria and need not necessarily be the fastest or shortest route. The selection of the route along which to guide the driver can be very sophisticated, and the selected route may take into account existing, predicted and dynamically and/or wirelessly received traffic and road information, historical information about road speeds, and the driver's own preferences for the factors determining road choice (for example the driver may specify that the route should not include motorways or toll roads).

In addition, the device may continually monitor road and traffic conditions, and offer to or choose to change the route over which the remainder of the journey is to be made due to changed conditions. Real time traffic monitoring systems, based on various technologies (e.g. mobile phone data exchanges, fixed cameras, GPS fleet tracking) are being used to identify traffic delays and to feed the information into notification systems.

PNDs of this type may typically be mounted on the dashboard or windscreen of a vehicle, but may also be formed as part of an on-board computer of the vehicle radio or indeed as part of the control system of the vehicle itself. The navigation device may also be part of a hand-held system, such as a PDA (Portable Digital Assistant) a media player, a mobile phone or the like, and in these cases, the normal functionality of the hand-held system is extended by means of the installation of software on the device to perform both route calculation and navigation along a calculated route.

Route planning and navigation functionality may also be provided by a desktop or mobile computing resource running appropriate software. For example, the Royal Automobile Club (RAC) provides an on-line route planning and navigation facility at http://www.rac.co.uk, which facility allows a user to enter a start point and a destination whereupon the server to which the user's PC is connected calculates a route (aspects of which may be user specified), generates a map, and generates a set of exhaustive navigation instructions for guiding the user from the selected start point to the selected destination. The facility also provides for pseudo three-dimensional rendering of a calculated route, and route preview functionality which simulates a user travelling along the route and thereby provides the user with a preview of the calculated route.

In the context of a PND, once a route has been calculated, the user interacts with the navigation device to select the desired calculated route, optionally from a list of proposed routes. Optionally, the user may intervene in, or guide the route selection process, for example by specifying that certain routes, roads, locations or criteria are to be avoided or are mandatory for a particular journey. The route calculation aspect of the PND forms one primary function, and navigation along such a route is another primary function.

During navigation along a calculated route, it is usual for such PNDs to provide visual and/or audible instructions to guide the user along a chosen route to the end of that route, i.e. the desired destination. It is also usual for PNDs to display map information on-screen during the navigation, such information regularly being updated on-screen so that the map information displayed is representative of the current location of the device, and thus of the user or user's vehicle if the device is being used for in-vehicle navigation.

An icon displayed on-screen typically denotes the current device location, and is centred with the map information of current and surrounding roads in the vicinity of the current device location and other map features also being displayed. Additionally, navigation information may be displayed, optionally in a status bar above, below or to one side of the displayed map information, examples of navigation information include a distance to the next deviation from the current road required to be taken by the user, the nature of that deviation possibly being represented by a further icon suggestive of the particular type of deviation, for example a left or right turn. The navigation function also determines the content, duration and timing of audible instructions by means of which the user can be guided along the route. As can be appreciated a simple instruction such as “turn left in 100 m” requires significant processing and analysis. As previously mentioned, user interaction with the device may be by a touch screen, or additionally or alternately by steering column mounted remote control, by voice activation or by any other suitable method.

A further important function provided by the device is automatic route re-calculation in the event that: a user deviates from the previously calculated route during navigation (either by accident or intentionally); real-time traffic conditions dictate that an alternative route would be more expedient and the device is suitably enabled to recognize such conditions automatically, or if a user actively causes the device to perform route re-calculation for any reason.

It is also known to allow a route to be calculated with user defined criteria; for example, the user may prefer a scenic route to be calculated by the device, or may wish to avoid any roads on which traffic congestion is likely, expected or currently prevailing. The device software would then calculate various routes and weigh more favourably those that include along their route the highest number of points of interest (known as POIs) tagged as being for example of scenic beauty, or, using stored information indicative of prevailing traffic conditions on particular roads, order the calculated routes in terms of a level of likely congestion or delay on account thereof. Other POI-based and traffic information-based route calculation and navigation criteria are also possible.

Although the route calculation and navigation functions are fundamental to the overall utility of PNDs, it is possible to use the device purely for information display, or “free-driving”, in which only map information relevant to the current device location is displayed, and in which no route has been calculated and no navigation is currently being performed by the device. Such a mode of operation is often applicable when the user already knows the route along which it is desired to travel and does not require navigation assistance.

Devices of the type described above, for example the 720T model manufactured and supplied by TomTom International B.V., provide a reliable means for enabling users to navigate from one position to another.

Frequently it is desired to park a vehicle in a chargeable parking area, or car park. Traditionally, chargeable vehicle parking has relied upon physical ticketing. In some ticket-based pre-payment systems a user pays a fee in advance of parking and is provided with a ticket, generally a self-adhesive ticket, for display in the vehicle indicating the duration of pre-payment. In other ticket-based post-payment systems, the user is presented with a ticket upon entry to the parking area which indicates, or has stored thereon, information indicating the time of entry to the parking area. When the user wishes to leave, a payment is made corresponding to the parking duration. More recently, phone-based parking payment systems have been introduced. In a phone based system, a user sets up an account with a parking provider (e.g. parking area operator) and registers information such as method of payment e.g. credit or debit card, vehicle registration information etc with the parking provider. In order to park, the user then either phones an automated system or sends an SMS message to the system identifying their parking location and the duration for which they wish to park so that a payment for the parking duration can be made to the parking provider. However, in many systems, both ticket and phone-based, the user must estimate in advance the duration of their parking. Furthermore, in many phone-based systems, the user incurs an additional cost for the telephone call or SMS message. Furthermore, in the phone-based system, the user must correctly identify their parking location which is generally performed by finding a sign or other indication displaying identification information which is time consuming and relies on accuracy from the user.

It is an aim of the present invention to address this problem, in particular to attempt to provide an apparatus, method and system which facilitates convenient payment for vehicle parking. It is an aim of some embodiments of the present invention to allow automatic payment for vehicle parking.

### SUMMARY OF THE INVENTION

In pursuit of this aim, a presently preferred embodiment of the present invention provides a navigation device arranged to communicate information to a server, characterised in that the navigation device is arranged to determine a period of time for which a vehicle carrying the navigation device is parked, and to communicate information to the server associated with the period of time.

Another embodiment of the present invention relates to a method of facilitating payment for a service, the method characterised by the steps of determining a period of time for which a vehicle carrying a navigation device is parked; communicating information associated with the period of time from the navigation device to the server; and facilitating payment for the period of time which the vehicle is parked.

Yet another embodiment of the present invention relates to computer software comprising one or more software modules operable, when executed in an execution environment, to cause a processor to perform a method which facilitates payment for a service, the method characterised by the steps of determining a period of time for which a vehicle carrying a navigation device is parked; communicating information associated with the period of time from the navigation device to the server; and facilitating payment for the period of time which the vehicle is parked.

According to still a further embodiment of the present invention there is provided a navigation device in wireless communication with a server; characterised in that the navigation device is arranged to communicate information to the server associated with a period of time during which a vehicle carrying the navigation device is parked; and the server is arranged to facilitate payment for the period of time for which the vehicle is parked.

According to another aspect of the present invention, there is provided a navigation device arranged to determine a time to output an indication to the according to a current location of the navigation device and a parking location.

Preferably, the indication alerts a user to a parking-related time. The parking related time may be an expiry of a parking-payment period or a closure of a car park.

According to another aspect of the present invention, there is provided a navigation device arranged to communicate information indicative of a location to a server and to receive information of one or more parking locations from the server.

Preferably, the location is a destination location or a current location of the navigation device. The parking location(s) may be determined to be proximal to the location. The navigation device may be arranged to receive a user input selecting one of a plurality of parking locations. The navigation device may alternatively be configured to select one of a plurality of parking locations according to predefined criteria.

Advantages of these embodiments are set out hereafter, and further details and features of each of these embodiments are defined in the accompanying dependent claims and elsewhere in the following detailed description.

### BRIEF DESCRIPTION OF THE DRAWINGS

Various aspects of the teachings of the present invention, and arrangements embodying those teachings, will hereafter be described by way of illustrative example with reference to the accompanying drawings, in which:

FIG. 1 is a schematic illustration of a Global Positioning System (GPS);

FIG. 2 is a schematic illustration of electronic components arranged to provide a navigation device;

FIG. 3 is a schematic illustration of the manner in which a navigation device may receive information over a wireless communication channel;

FIGS. 4A and 4B are illustrative perspective views of a navigation device;

FIG. 5 is a schematic representation of the software employed by the navigation device;

FIG. 6 is an illustration of a method according to an embodiment of the invention;

FIG. 7 is an illustration of a system according to an embodiment of the invention;

FIG. 8 is an illustration of a method according to an embodiment of the invention;

FIG. 9 is an illustration of a further method according to an embodiment of the invention;

FIG. 10 is an illustration of a still further method according to an embodiment of the invention; and

FIG. 11 is an illustration of another method according to an embodiment of the invention.

### DETAILED DESCRIPTION OF PREFERRED EMBODIMENTS

Preferred embodiments of the present invention will now be described with particular reference to a PND. It should be remembered, however, that the teachings of the present invention are not limited to PNDs but are instead universally applicable to any type of processing device that is configured to execute navigation software so as to provide route planning and navigation functionality. It follows therefore that in the context of the present application, a navigation device is intended to include (without limitation) any type of route planning and navigation device, irrespective of whether that device is embodied as a PND, a navigation device built into a vehicle, or indeed a computing resource (such as a desktop or portable personal computer (PC), mobile telephone or portable digital assistant (PDA)) executing route planning and navigation software.

It will also be apparent from the following that the teachings of the present invention even have utility in circumstances where a user is not seeking instructions on how to navigate from one point to another, but merely wishes to be provided with a view of a given location. In such circumstances the “destination” location selected by the user need not have a corresponding start location from which the user wishes to start navigating, and as a consequence references herein to the “destination” location or indeed to a “destination” view should not be interpreted to mean that the generation of a route is essential, that travelling to the “destination” must occur, or indeed that the presence of a destination requires the designation of a corresponding start location.

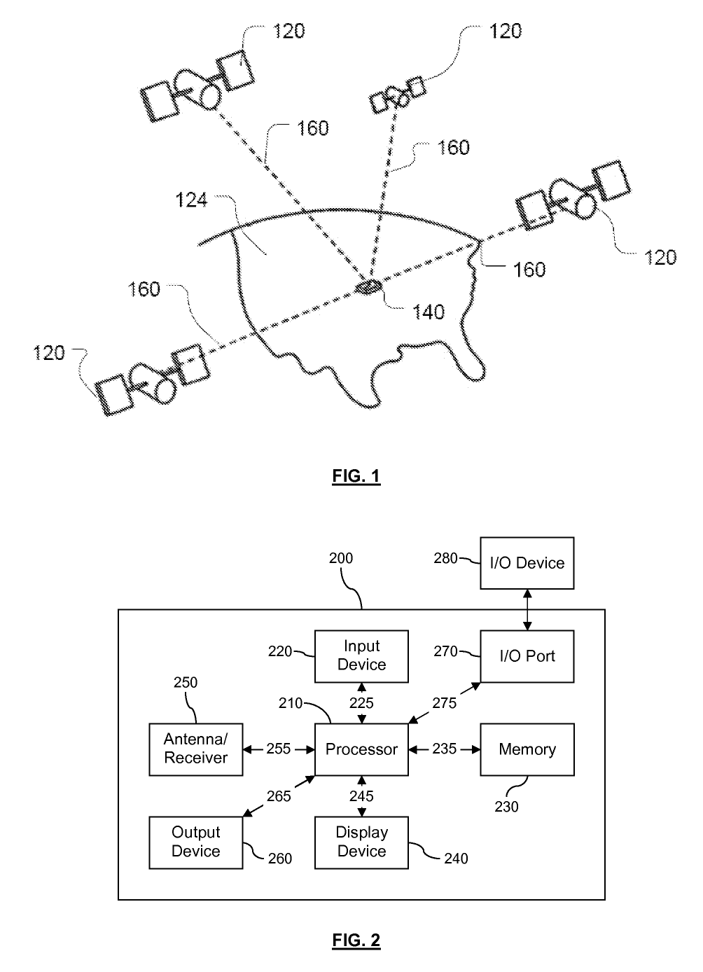

With the above provisos in mind, FIG. 1 illustrates an example view of Global Positioning System (GPS), usable by navigation devices. Such systems are known and are used for a variety of purposes. In general, GPS is a satellite-radio based navigation system capable of determining continuous position, velocity, time, and in some instances direction information for an unlimited number of users. Formerly known as NAVSTAR, the GPS incorporates a plurality of satellites which orbit the earth in extremely precise orbits. Based on these precise orbits, GPS satellites can relay their location to any number of receiving units.

The GPS system is implemented when a device, specially equipped to receive GPS data, begins scanning radio frequencies for GPS satellite signals. Upon receiving a radio signal from a GPS satellite, the device determines the precise location of that satellite via one of a plurality of different conventional methods. The device will continue scanning, in most instances, for signals until it has acquired at least three different satellite signals (noting that position is not normally, but can be determined, with only two signals using other triangulation techniques). Implementing geometric triangulation, the receiver utilizes the three known positions to determine its own two-dimensional position relative to the satellites. This can be done in a known manner. Additionally, acquiring a fourth satellite signal will allow the receiving device to calculate its three dimensional position by the same geometrical calculation in a known manner. The position and velocity data can be updated in real time on a continuous basis by an unlimited number of users.

As shown in FIG. 1, the GPS system is denoted generally by reference numeral 100. A plurality of satellites 120 are in orbit about the earth 124. The orbit of each satellite 120 is not necessarily synchronous with the orbits of other satellites 120 and, in fact, is likely asynchronous. A GPS receiver 140 is shown receiving spread spectrum GPS satellite signals 160 from the various satellites 120.

The spread spectrum signals 160, continuously transmitted from each satellite 120, utilize a highly accurate frequency standard accomplished with an extremely accurate atomic clock. Each satellite 120, as part of its data signal transmission 160, transmits a data stream indicative of that particular satellite 120. It is appreciated by those skilled in the relevant art that the GPS receiver device 140 generally acquires spread spectrum GPS satellite signals 160 from at least three satellites 120 for the GPS receiver device 140 to calculate its two-dimensional position by triangulation. Acquisition of an additional signal, resulting in signals 160 from a total of four satellites 120, permits the GPS receiver device 140 to calculate its three-dimensional position in a known manner.

FIG. 2 is an illustrative representation of electronic components of a navigation device 200 according to a preferred embodiment of the present invention, in block component format. It should be noted that the block diagram of the navigation device 200 is not inclusive of all components of the navigation device, but is only representative of many example components.

The navigation device 200 is located within a housing (not shown). The housing includes a processor 210 connected to an input device 220 and a display screen 240. The input device 220 can include a keyboard device, voice input device, touch panel and/or any other known input device utilised to input information; and the display screen 240 can include any type of display screen such as an LCD display, for example. In a particularly preferred arrangement the input device 220 and display screen 240 are integrated into an integrated input and display device, including a touchpad or touchscreen input so that a user need only touch a portion of the display screen 240 to select one of a plurality of display choices or to activate one of a plurality of virtual buttons.

The navigation device may include an output device 260, for example an audible output device (e.g. a loudspeaker). As output device 260 can produce audible information for a user of the navigation device 200, it is should equally be understood that input device 240 can include a microphone and software for receiving input voice commands as well.

In the navigation device 200, processor 210 is operatively connected to and set to receive input information from input device 220 via a connection 225, and operatively connected to at least one of display screen 240 and output device 260, via output connections 245, to output information thereto. Further, the processor 210 is operably coupled to a memory resource 230 via connection 235 and is further adapted to receive/send information from/to input/output (I/O) ports 270 via connection 275, wherein the I/O port 270 is connectible to an I/O device 280 external to the navigation device 200. The memory resource 230 comprises, for example, a volatile memory, such as a Random Access Memory (RAM) and a non-volatile memory, for example a digital memory, such as a flash memory. The external I/O device 280 may include, but is not limited to an external listening device such as an earpiece for example. The connection to I/O device 280 can further be a wired or wireless connection to any other external device such as a car stereo unit for hands-free operation and/or for voice activated operation for example, for connection to an ear piece or head phones, and/or for connection to a mobile phone for example, wherein the mobile phone connection may be used to establish a data connection between the navigation device 200 and the internet or any other network for example, and/or to establish a connection to a server via the internet or some other network for example.

FIG. 2 further illustrates an operative connection between the processor 210 and an antenna/receiver 250 via connection 255, wherein the antenna/receiver 250 can be a GPS antenna/receiver for example. It will be understood that the antenna and receiver designated by reference numeral 250 are combined schematically for illustration, but that the antenna and receiver may be separately located components, and that the antenna may be a GPS patch antenna or helical antenna for example.

Further, it will be understood by one of ordinary skill in the art that the electronic components shown in FIG. 2 are powered by power sources (not shown) in a conventional manner. As will be understood by one of ordinary skill in the art, different configurations of the components shown in FIG. 2 are considered to be within the scope of the present application. For example, the components shown in FIG. 2 may be in communication with one another via wired and/or wireless connections and the like. Thus, the scope of the navigation device 200 of the present application includes a portable or handheld navigation device 200.

In addition, the portable or handheld navigation device 200 of FIG. 2 can be connected or “docked” in a known manner to a vehicle such as a bicycle, a motorbike, a car or a boat for example. Such a navigation device 200 is then removable from the docked location for portable or handheld navigation use.

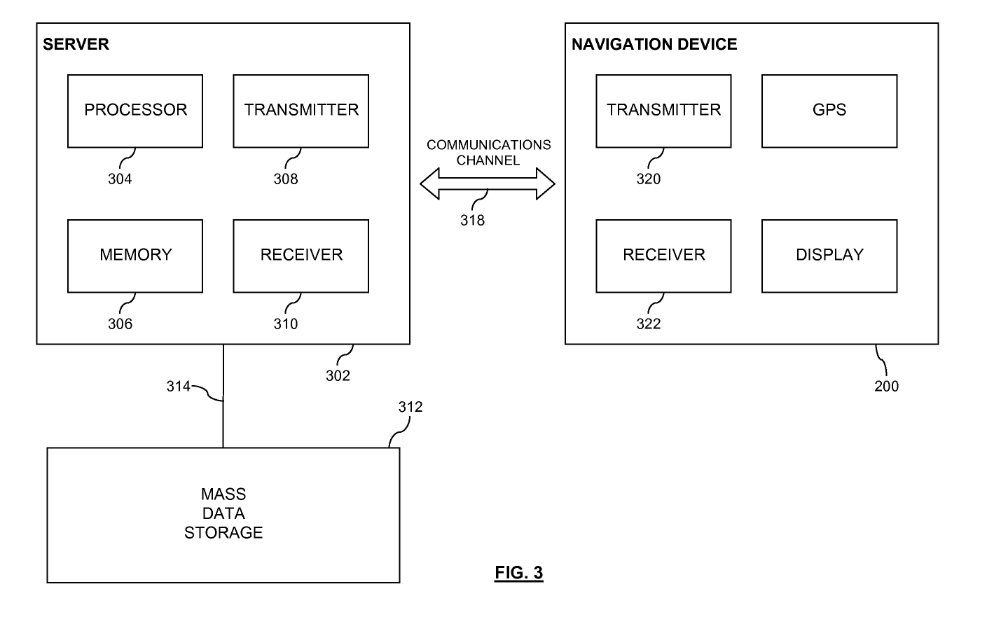

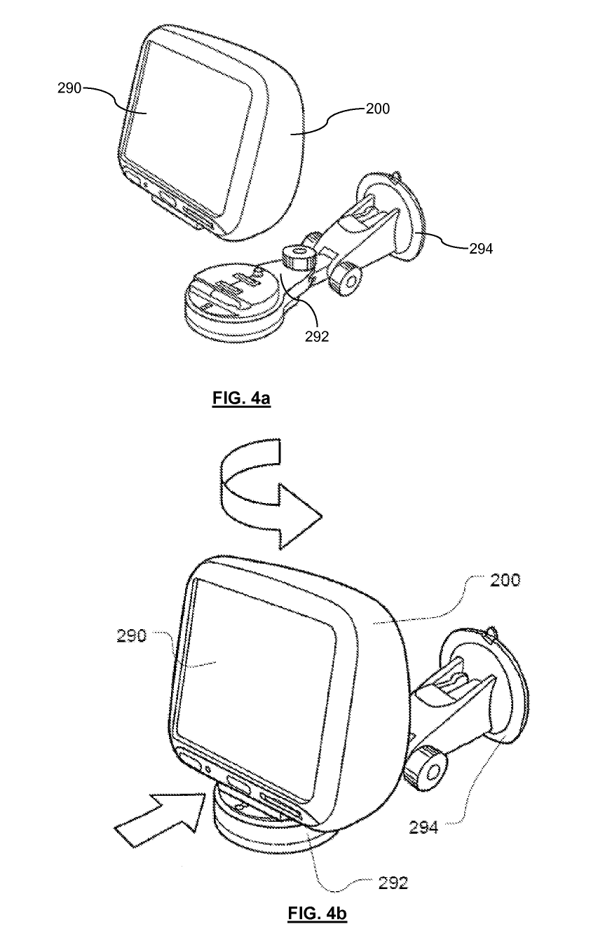

Referring now to FIG. 3, the navigation device 200 may establish a “mobile” or telecommunications network connection with a server 302 via a mobile device (not shown) (such as a mobile phone, PDA, and/or any device with mobile phone technology) establishing a digital connection (such as a digital connection via known Bluetooth technology for example). Thereafter, through its network service provider, the mobile device can establish a network connection (through the internet for example) with a server 302. As such, a “mobile” network connection is established between the navigation device 200 (which can be, and often times is mobile as it travels alone and/or in a vehicle) and the server 302 to provide a “real-time” or at least very “up to date” gateway for information.

The establishing of the network connection between the mobile device (via a service provider) and another device such as the server 302, using an internet (such as the World Wide Web) for example, can be done in a known manner. This can include use of TCP/IP layered protocol for example. The mobile device can utilize any number of communication standards such as CDMA, GSM, WAN, etc.

As such, an internet connection may be utilised which is achieved via data connection, via a mobile phone or mobile phone technology within the navigation device 200 for example. For this connection, an internet connection between the server 302 and the navigation device 200 is established. This can be done, for example, through a mobile phone or other mobile device and a GPRS (General Packet Radio Service)-connection (GPRS connection is a high-speed data connection for mobile devices provided by telecom operators; GPRS is a method to connect to the internet).

The navigation device 200 can further complete a data connection with the mobile device, and eventually with the internet and server 302, via existing Bluetooth technology for example, in a known manner, wherein the data protocol can utilize any number of standards, such as the GSRM, the Data Protocol Standard for the GSM standard, for example.

The navigation device 200 may include its own mobile phone technology within the navigation device 200 itself (including an antenna for example, or optionally using the internal antenna of the navigation device 200). The mobile phone technology within the navigation device 200 can include internal components as specified above, and/or can include an insertable card (e.g. Subscriber Identity Module or SIM card), complete with necessary mobile phone technology and/or an antenna for example. As such, mobile phone technology within the navigation device 200 can similarly establish a network connection between the navigation device 200 and the server 302, via the internet for example, in a manner similar to that of any mobile device.

For GPRS phone settings, a Bluetooth enabled navigation device may be used to correctly work with the ever changing spectrum of mobile phone models, manufacturers, etc., model/manufacturer specific settings may be stored on the navigation device 200 for example. The data stored for this information can be updated.

In FIG. 3 the navigation device 200 is depicted as being in communication with the server 302 via a generic communications channel 318 that can be implemented by any of a number of different arrangements. The server 302 and a navigation device 200 can communicate when a connection via communications channel 318 is established between the server 302 and the navigation device 200 (noting that such a connection can be a data connection via mobile device, a direct connection via personal computer via the internet, etc.).

The server 302 includes, in addition to other components which may not be illustrated, a processor 304 operatively connected to a memory 306 and further operatively connected, via a wired or wireless connection 314, to a mass data storage device 312. The processor 304 is further operatively connected to transmitter 308 and receiver 310, to transmit and send information to and from navigation device 200 via communications channel 318. The signals sent and received may include data, communication, and/or other propagated signals. The transmitter 308 and receiver 310 may be selected or designed according to the communications requirement and communication technology used in the communication design for the navigation system 200. Further, it should be noted that the functions of transmitter 308 and receiver 310 may be combined into a signal transceiver.

Server 302 is further connected to (or includes) a mass storage device 312, noting that the mass storage device 312 may be coupled to the server 302 via communication link 314. The mass storage device 312 contains a store of navigation data and map information, and can again be a separate device from the server 302 or can be incorporated into the server 302.

The navigation device 200 is adapted to communicate with the server 302 through communications channel 318, and includes processor, memory, etc. as previously described with regard to FIG. 2, as well as transmitter 320 and receiver 322 to send and receive signals and/or data through the communications channel 318, noting that these devices can further be used to communicate with devices other than server 302. Further, the transmitter 320 and receiver 322 are selected or designed according to communication requirements and communication technology used in the communication design for the navigation device 200 and the functions of the transmitter 320 and receiver 322 may be combined into a single transceiver.

Software stored in server memory 306 provides instructions for the processor 304 and allows the server 302 to provide services to the navigation device 200. One service provided by the server 302 involves processing requests from the navigation device 200 and transmitting navigation data from the mass data storage 312 to the navigation device 200. Another service provided by the server 302 includes processing the navigation data using various algorithms for a desired application and sending the results of these calculations to the navigation device 200.

The communication channel 318 generically represents the propagating medium or path that connects the navigation device 200 and the server 302. Both the server 302 and navigation device 200 include a transmitter for transmitting data through the communication channel and a receiver for receiving data that has been transmitted through the communication channel.

The communication channel 318 is not limited to a particular communication technology. Additionally, the communication channel 318 is not limited to a single communication technology; that is, the channel 318 may include several communication links that use a variety of technology. For example, the communication channel 318 can be adapted to provide a path for electrical, optical, and/or electromagnetic communications, etc. As such, the communication channel 318 includes, but is not limited to, one or a combination of the following: electric circuits, electrical conductors such as wires and coaxial cables, fibre optic cables, converters, radio-frequency (RF) waves, the atmosphere, empty space, etc. Furthermore, the communication channel 318 can include intermediate devices such as routers, repeaters, buffers, transmitters, and receivers, for example.

In one illustrative arrangement, the communication channel 318 includes telephone and computer networks. Furthermore, the communication channel 318 may be capable of accommodating wireless communication such as radio frequency, microwave frequency, infrared communication, etc. Additionally, the communication channel 318 can accommodate satellite communication.

The communication signals transmitted through the communication channel 318 include, but are not limited to, signals as may be required or desired for given communication technology. For example, the signals may be adapted to be used in cellular communication technology such as Time Division Multiple Access (TDMA), Frequency Division Multiple Access (FDMA), Code Division Multiple Access (CDMA), Global System for Mobile Communications (GSM), etc. Both digital and analogue signals can be transmitted through the communication channel 318. These signals may be modulated, encrypted and/or compressed signals as may be desirable for the communication technology.

The server 302 includes a remote server accessible by the navigation device 200 via a wireless channel. The server 302 may include a network server located on a local area network (LAN), wide area network (WAN), virtual private network (VPN), etc.

The server 302 may include a personal computer such as a desktop or laptop computer, and the communication channel 318 may be a cable connected between the personal computer and the navigation device 200. Alternatively, a personal computer may be connected between the navigation device 200 and the server 302 to establish an internet connection between the server 302 and the navigation device 200. Alternatively, a mobile telephone or other handheld device may establish a wireless connection to the internet, for connecting the navigation device 200 to the server 302 via the internet.

The navigation device 200 may be provided with information from the server 302 via information downloads which may be periodically updated automatically or upon a user connecting navigation device 200 to the server 302 and/or may be more dynamic upon a more constant or frequent connection being made between the server 302 and navigation device 200 via a wireless mobile connection device and TCP/IP connection for example. For many dynamic calculations, the processor 304 in the server 302 may be used to handle the bulk of the processing needs, however, processor 210 of navigation device 200 can also handle much processing and calculation, oftentimes independent of a connection to a server 302.

As indicated above in FIG. 2, a navigation device 200 includes a processor 210, an input device 220, and a display screen 240. The input device 220 and display screen 240 are integrated into an integrated input and display device to enable both input of information (via direct input, menu selection, etc.) and display of information through a touch panel screen, for example. Such a screen may be a touch input LCD screen, for example, as is well known to those of ordinary skill in the art. Further, the navigation device 200 can also include any additional input device 220 and/or any additional output device 241, such as audio input/output devices for example.

FIGS. 4A and 4B are perspective views of a navigation device 200. As shown in FIG. 4A, the navigation device 200 may be a unit that includes an integrated input and display device 290 (a touch panel screen for example) and the other components of FIG. 2 (including but not limited to internal GPS receiver 250, microprocessor 210, a power supply, memory systems 230, etc.).

The navigation device 200 may sit on an arm 292, which itself may be secured to a vehicle dashboard/window/etc. using a suction cup 294. This arm 292 is one example of a docking station to which the navigation device 200 can be docked.

As shown in FIG. 4B, the navigation device 200 can be docked or otherwise connected to an arm 292 of the docking station by snap connecting the navigation device 292 to the arm 292 for example. The navigation device 200 may then be rotatable on the arm 292, as shown by the arrow of FIG. 4B. To release the connection between the navigation device 200 and the docking station, a button on the navigation device 200 may be pressed, for example. Other equally suitable arrangements for coupling and decoupling the navigation device to a docking station are well known to persons of ordinary skill in the art.

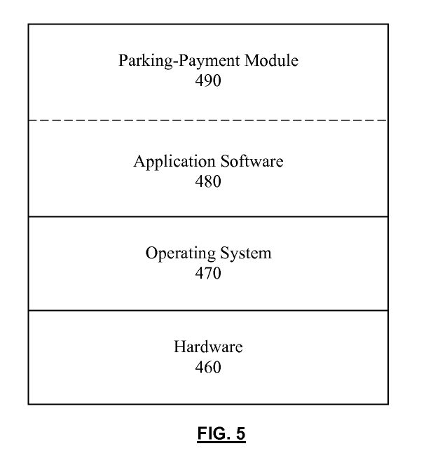

Referring now to FIG. 5 of the accompanying drawings, the memory resource 230 stores a boot loader program (not shown) that is executed by the processor 210 in order to load an operating system 470 from the memory resource 230 for execution by functional hardware components 460, which provides an environment in which application software 480 can run. The operating system 470 serves to control the functional hardware components 460 and resides between the application software 480 and the functional hardware components 460. The application software 480 provides an operational environment including the GUI that supports core functions of the navigation device 200, for example map viewing, route planning, navigation functions and any other functions associated therewith. In accordance with the preferred embodiment of the present invention, part of this functionality comprises a parking-payment module 490, the function of which will now be described in detail in connection with the following figures.

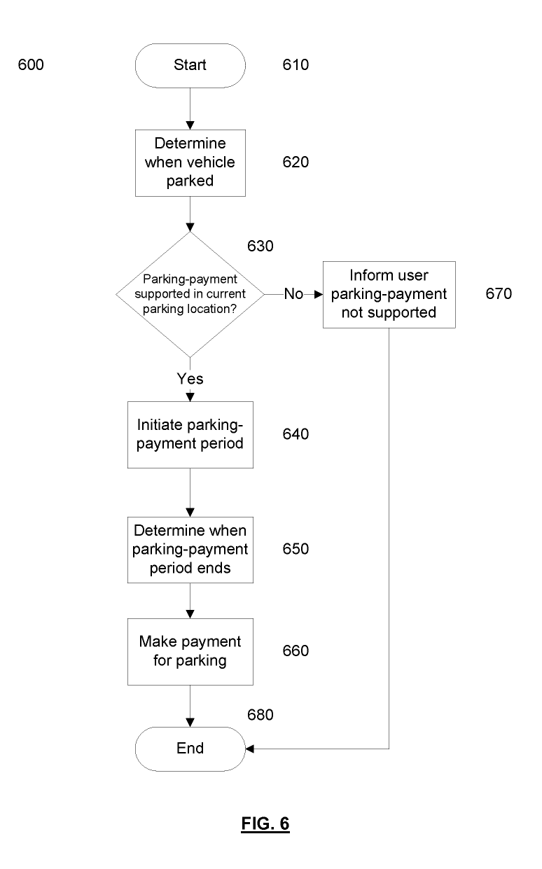

FIG. 6 illustrates a method 600 according to an embodiment of the present invention which begins in step 610. In step 620 a navigation device 200, such as that illustrated in FIG. 2, determines when a vehicle carrying the navigation device 200 parks. In some embodiments, the navigation device 200 automatically determines the parking of the vehicle, whilst in other embodiments the navigation device 200 receives an input from the user indicating that they have parked. Embodiments of methods for determining the parking of the vehicle will be explained in detail later. In step 630 it is determined whether parking-payment is supported in a current parking location. That is, whether the location at which the vehicle carrying the navigation device 200 allows payment for parking to be made by embodiments of the present invention. If parking-payment is supported, then in step 640 a parking-payment period is initiated and in step 650 it is determined when the parking-payment period ends. The parking-payment period is the period for which payment is to be made for parking i.e. the period for which the vehicle is parked. Embodiments of methods for performing steps 630-650 will be described in detail later. In step 660 a payment for the parking period is made and the method ends in step 680. However, if in step 630 it had been determined that parking-payment by embodiments of the present was not supported at the parking location, the user is informed in step 670 and the method proceeds to step 680.

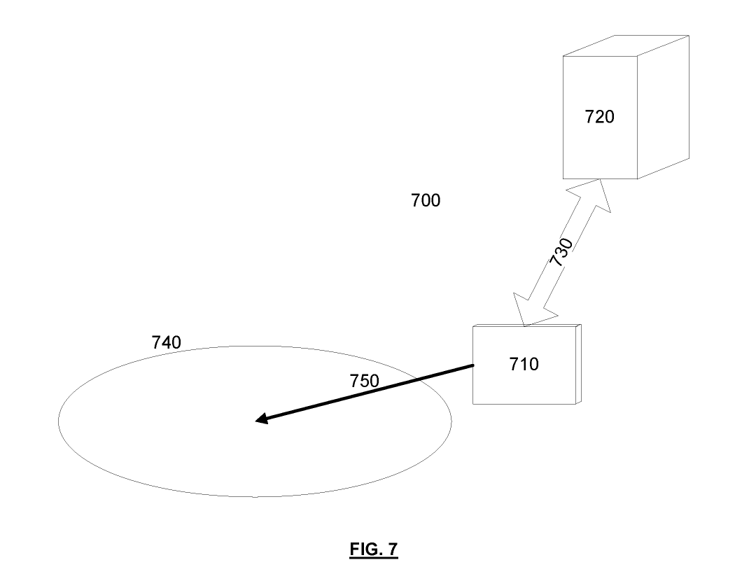

FIG. 7 illustrates a system 700 of an embodiment of the invention. The system 700 comprises a navigation device 710, such as that illustrated in more detail in FIG. 2, and a server 720, such as that illustrated in more detail in FIG. 3. The navigation device 710 and server 720 are in wireless communication via a data communications channel 730 which can be implemented by a number of different arrangements, either directly or indirectly via another device such as a mobile telecommunications device e.g. mobile phone. The navigation device 710 is carried by a vehicle which is not shown in FIG. 7 for clarity. However, as a result of being carried by the vehicle, the navigation device 710 is moved into a parking area 740, as indicated by arrow 750, where the vehicle is parked for a parking-period or parking duration, as will be explained. The server 720 stores, or has access to, a storage device storing user information related to a user of the navigation device. The user information comprises information identifying the user e.g. name etc., information identifying the vehicle carrying the navigation device 710 and payment information identifying a method of payment for parking services by the user of the navigation device 710. The method of payment may be credit or debit card details for the user, the user may hold a pre-paid account with the server 720 containing credits for parking payment, or the user may receive a periodic eg monthly invoice for parking services which requires later payment. In cases where the navigation device 710 is used by a plurality of users and/or in a plurality of vehicles, it is envisaged that user and/or vehicle profiles may be established which allow the user of the navigation device 710 to select a corresponding user profile from a plurality of user profiles e.g. “Steven”, “Chris”, “Mary” . . . and/or a vehicle profile from a plurality of vehicle profiles e.g. “Car 1”, “Car 2” . . . . In the case of selecting a user profile the payment information may be linked to that user profile, such that each user may have a corresponding payment method. In some cases, the payment method may be unique to each user, but it is also envisaged that a plurality of users may share a single payment method e.g. company or joint credit card. The one or more vehicle profiles may comprise a make and model of the vehicle, registration information of the vehicle and/or a colour of the vehicle. Such information may be required to be supplied to a computer system (not shown) of a parking area 740 operator, thereby enabling the parking area operator to identify vehicles having paid for parking.

As noted above, in step 620 the parking-payment module 490 executing on the navigation device 710 determines when the vehicle carrying the navigation device 710 parks. In some embodiments, this may be achieved by receiving an input from the user indicating that they have parked the vehicle. For example, a “parking” button may be provided on the navigation device 710 for activation by the user to indicate parking of the vehicle. In other embodiments, a graphical item may be displayed on the display device 240 of the navigation device 710 for receiving a user input to indicate parking of the vehicle. Such a graphical item may only be displayed when the navigation device 710 determines that the vehicle is stationary i.e. that a current location of the vehicle is not changing or has not changed for a predetermined period of time e.g. 10 seconds. However, in other embodiments of the invention, the parking-payment module 490 may automatically determine that the vehicle has parked. The parking-payment module 490 may automatically determine that the vehicle has parked in one embodiment by determining that the current location of the vehicle has ceased to change, or has not changed for a predetermined period of time e.g. 10 seconds. However, in order to avoid incorrectly determining that the vehicle has parked e.g. when temporarily stopped whilst driving, the parking-payment module 490 may compare the location at which the vehicle has stopped with map data or with information indicating the location of one or more parking areas previously communicated to the device as will be explained later, to determine that the vehicle has stopped in a parking area, or at least an area which is not part of the road system. Alternatively or additionally, the parking-payment module 490 may receive information relating to the status of the vehicle and sub-systems thereof which may be used to determine parking of the vehicle. The navigation device 710 may be communicatively coupled to the vehicle e.g. via a local wireless network, such as Bluetooth, or via a wired connection, such as CAN bus of the vehicle, to receive information indicating the status of the vehicle and the sub-systems thereof. Parking of the vehicle may be determined from information indicating one or more of: the vehicle's electrical system is powered or shut down, keys have been removed from an ignition of the vehicle, one or more doors of the vehicle have been opened or an engine of the vehicle has been stopped. A determination of the vehicle's electrical system being powered down may also be made from a power supply to the navigation device from the vehicle. Furthermore, in some embodiments, parking of the vehicle may also be made or supplemented by an indication of the navigation device being removed from the docking arm 292. Advantageously, by determining parking from the vehicle's status, more accurate and rapid parking determinations may be made. In another alternative embodiment, the navigation device 710 may receive a wireless signal indicating that it is proximal to, or within, a parking area, such as a signal transmitted by a transmitter in the parking area 740.

Once the parking-payment module 490 has determined that the vehicle has parked, a determination is made whether the current parking location supports parking-payment according to embodiments of the present invention. In some embodiments of the present invention, the determination is made by the navigation device 710. However, in other embodiments the determination is made by the server 720 and information indicative of the determination communicated to the navigation device 710 via the communications channel 730.

Firstly embodiments in which the navigation device 710 determines that the vehicle is parked in a parking location supporting parking-payment will be explained. In some embodiments, the navigation 710 may have received information from the server 720 identifying one or more parking areas, as will be explained in further detail below. In this case, the navigation device 710 may compare the current parking location i.e. location of the navigation device 710 against the location of the one or more parking areas previously received from the server 720 to determine that the vehicle is parked in a parking location supporting parking-payment. However, in another embodiment, the navigation device 710 may compare the current parking location against map data which indicates one or more parking areas supporting parking payment according to embodiments of the invention to determine that the vehicle is parked in a parking location supporting parking-payment.

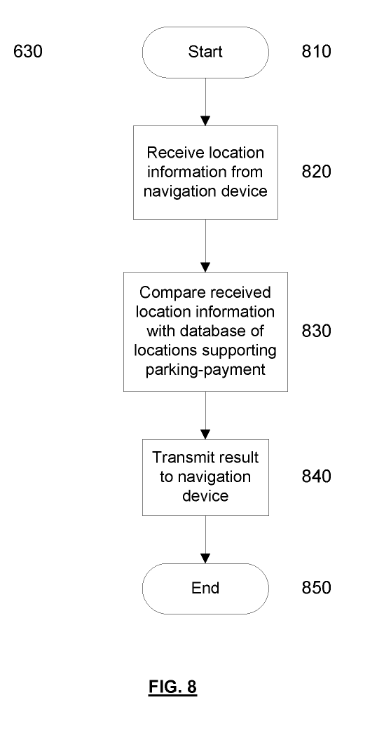

In other embodiments, the server 720 determines that the vehicle is parked in a parking location supporting parking-payment, based upon information received from the navigation device 710. Referring to FIG. 8, method steps are shown which may be performed in embodiments of step 630 shown in FIG. 6. The method begins in step 810 and in step 820 information is received by the server 720 indicating a geographical location at which the vehicle containing the navigation device 710 has parked. The geographical location may be indicated by coordinates in a predetermined coordinate system, such as longitude and latitude. In step 830 the geographical location of the navigation device 710 is compared against a store of locations supporting parking-payment. In some embodiments, the store may be a database of parking areas 740 supporting parking-payment according to embodiments of the invention. The result of the determination is communicated to the navigation device 710 from the sever 720 via the communications channel 730 in step 840. The result may be a binary indication and may be communicated in a parking-payment supported message. The message may, in some embodiments, communicate further information to the navigation device 710 regarding the parking area 740, such as cost information e.g. information indicating a cost per unit time for parking in that parking area and/or temporal information regarding a payment-period or maximum stay duration in the parking area. For example, the information may indicate that payment is made for each whole hour and/or that the maximum parking duration is, for example, two hours.

As a result of the determination process, the navigation device 710 may be arranged to display an indication on the display 240 of whether parking-payment is supported in the current location. The display device 240 may display a message informing the user that parking payment is not supported and advising them that other payment means must be used, or may display a message indicating that parking payment is supported at the current location. The message displayed on the display device 240 may further comprise information related to the parking area 740, such as the cost per unit time obtained from local storage or the server 720.

If parking-payment is supported in the parking location, the navigation device 710 may either require user input confirming that the user wishes to park in the current location e.g. accepting the cost per unit hour, or the navigation device 710 may automatically inform the server 720 that the parking period should begin, as in step 640 shown in FIG. 6. The navigation device 710 may send a message to the server 720 indicating that the parking-period should begin i.e. that a payment will be made for the vehicle's parking from the time of the message. Advantageously, receipt of the message by the server 720 allows information indicating that the vehicle will be paying for parking to be communicated from the server 720 to a computer system of the parking area provider i.e. car park owner or operator so that parking enforcement of the parking area 740 may be informed. Furthermore, the message also allows the server 720 to determine the time at which parking begins for payment calculation.

The parking-payment period ends, in step 650 shown in FIG. 6, in response to the navigation device 710 sending a further message to the server 720. In some embodiments, the parking-payment module 490 of the navigation device 710 automatically determines that the parking-payment period should end based upon a location of the vehicle. However, in other embodiments the user provides an input to the navigation device 710 indicating that the parking-payment period should end.

The parking-payment module 490 may determine that the vehicle has ceased to be parked based upon the location of the navigation device 710. Once the location of the navigation device 710 changes, the parking payment module 710 may determine that the vehicle is not parked. In some embodiments, the parking payment module 490 may determine that the vehicle is not parked once the location changes more than a predetermined distance e.g. 50 m. In other embodiments, once the parking-payment module 490 has initiated the parking-payment period, an indication that the navigation device 710 is in a “parked” mode may be displayed on the display device 240. The displayed indication may comprise a control allowing the user to end the parking-payment period e.g. a graphical button or the like. In some embodiments, activation of the control causes the parking-payment module 490 to end the parking-payment period. However, in other embodiments, the parking-payment module may only determine the end of the parking payment period once the location of the navigation device 710 changes by more than a predetermined amount following the receipt of the user input. Advantageously, this prevents a user from fraudulently ending the parking-payment period without leaving the parking area 740. Also in step 650 the navigation device 710 may display a summary of the parking-payment period e.g. information indicating the length of the parking payment period and/or a cost of the parking-payment period.

In step 660 the server 720 makes a payment for the parking utilising the payment information held by the server 720. For example, the server 720 may charge the user's credit or debit car, or may debit the user's account held with the server 720. The server 720 may send confirmation to the navigation device 710 that the payment has been successful and information indicating the successful payment may be displayed on the display device 240 of the navigation device 710.

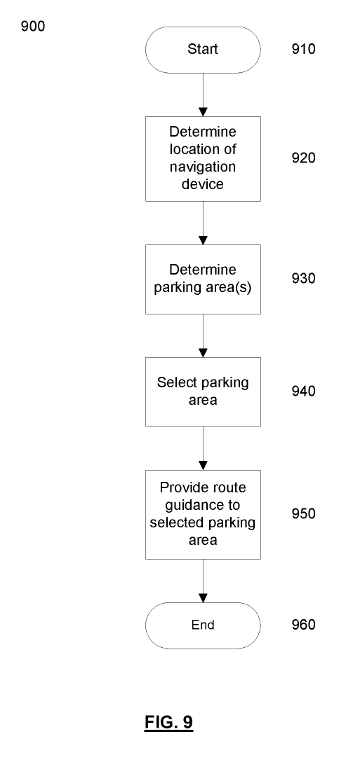

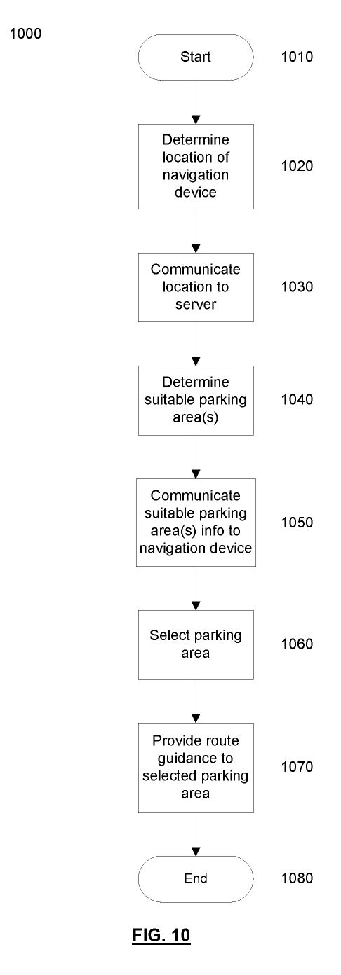

As noted above, in some embodiments of the invention, the user may be directed to a suitable parking area by the navigation device 710. Exemplary embodiments of the invention will now be explained with reference firstly to FIG. 9. A method 900 of providing route guidance to a parking area 740 according to an embodiment of the invention will now be explained. The method 900 begins in step 910. In step 920 a current location of a navigation device 710 is determined, such as the location of the navigation device 710 in FIG. 7. The location of the navigation device 710 may be determined from received GPS signals. Based upon the determined location, in step 930 one or more corresponding parking areas 740 are determined. The parking areas 740 determined in step 730 may be, in some embodiments, a predetermined number of parking areas. However, in other embodiments, the parking areas 740 may be those parking areas within a predetermined distance of the location of the navigation device 710. For example, the parking areas determined in step 930 may be those within 1, 2 or 5 km of the location of the navigation device 710. It will be realised that other distances may be considered. The distance may be selected according to an environment surrounding the navigation device 710. For example, if the current location of the navigation device 710 is determined to be in an urban environment, where there would be expected to be numerous parking areas, then the distance considered may be reduced to limit the determined number of parking areas. However if the environment is rural, where parking areas would be expected to be less numerous, then the distance may be correspondingly increased. In step 940 a parking area is selected. If, in step 930, only a single parking area had been determined e.g. only one parking area is within the determined distance, then that parking area may be automatically selected in step 940. However, if a plurality of parking areas have been determined in step 830 then a selection of one parking area is made from amongst those parking areas. The parking area may be automatically selected in step 940 according to one or more predetermined criteria. For example, a nearest parking area may be selected or a cheapest (lowest cost) parking area may be selected if cost information for the determined parking areas is known. Other criteria may be used as appropriate. The criteria may be stored as part of the current user and/or vehicle profile. For example, the user Chris” may prefer a nearest parking area, whilst the user “Mary” may prefer the cheapest parking area. Furthermore, vehicle criteria may affect the selection e.g. Carl may include height information indicating that the vehicle is a large or tall vehicle, according to which a selection of an appropriate parking area may be made. In other embodiments, information identifying the plurality of parking areas determined in step 930 is displayed on the display 240 and a user input is received by the navigation device 710 to select one of the displayed parking areas. Once a parking area 740 has been selected, in step 950 route guidance from the current location of the navigation device 710 is provided to direct the user to the selected parking area. The method ends in step 960.

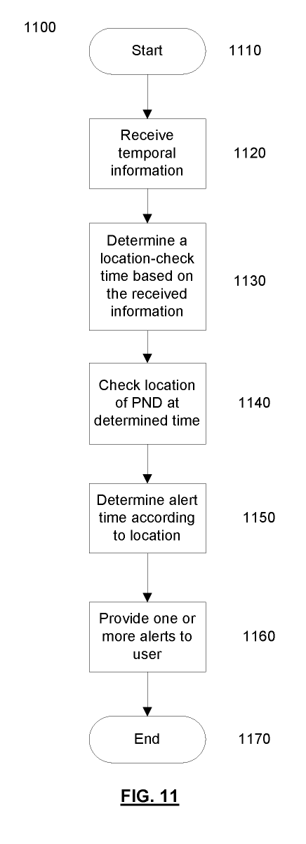

The above-described method may be performed by a navigation device 710 with reference to stored parking area information which identifies a plurality of parking areas. In some embodiments the parking information is stored on a store directly accessible to the navigation device 710, such as memory 230. The parking area information may form part of the map data. However, as will be explained with reference to FIG. 10, in other embodiments the method may be performed in conjunction with a server, such as server 720 shown in FIG. 7.

Referring to FIG. 10, a method 1100 for providing route guidance to a parking area 740 is shown which begins in step 1010. In step 1020 a current location of a navigation device, such as navigation device 710 shown in FIG. 7, is determined, for example with reference to received GPS signals. In step 1030 location information identifying the location of the navigation device 710 is communicated from the navigation device 710 to a server, such as server 720 shown in FIG. 7, via communications channel 730. The location information may identify the location of the navigation device 710 in a predetermined coordinate system, such as longitude and latitude. In step 1040 one or more suitable parking areas are determined by the server 720 according to the received location information. The parking areas 740 determined in step 1040 may be, in some embodiments, a predetermined number of parking areas. However, in other embodiments, the parking areas may be those parking areas within a predetermined distance of the location of the navigation device 710. For example, the parking areas determined in step 1040 may be those within 1, 2 or 5 km of the location of the navigation device 710. It will be realised that other distances may be considered. The distance may be selected according to an environment surrounding the navigation device 710. For example, if the current location of the navigation device 710 is determined to be in an urban environment, where there would be expected to be numerous parking areas, then the distance considered may be reduced to limit the determined number of parking areas. However if the environment is rural, where parking areas would be expected to be less numerous, then the distance may be correspondingly increased. In step 1050 information identifying the one or more suitable parking areas determined in step 1040 is communicated to the navigation device 710 via the communications channel 730. The communicated information may identify the locations of the one or more determined parking areas. In some embodiments, the information communicated to the navigation device 710 includes information relating to other aspects of the determined parking areas. The additional information may include price information, for example indicating a cost per unit time for parking in each parking area, opening time information indicating opening hours of each parking area if the parking area is not 24 hr; maximum stay information indicating a maximum stay duration of the parking area; and other restriction information, for example relating to a maximum size of vehicles allowed to park each parking area. It will be realised that not all information is communicated for every parking area e.g. some information may be communicated for some parking areas, whilst other information is communicated for one or more other parking areas. In step 1060 one of the communicated parking areas is selected. The parking area may be automatically selected in step 1060 by the navigation device 710, e.g. by the parking-payment module 490, according to one or more predetermined criteria. For example, a nearest parking area may be selected or a cheapest (lowest cost) parking area may be selected if cost information for the determined parking areas is known. Other criteria may be used as appropriate. The criteria may be stored as part of the current user and/or vehicle profile. For example, the user Chris” may prefer a nearest parking area, whilst the user “Mary” may prefer the cheapest parking area. Furthermore, vehicle criteria may affect the selection e.g. Carl may include height information indicating that the vehicle is a large or tall vehicle, according to which a selection of an appropriate parking area may be made. In other embodiments, information identifying the plurality of parking areas communicated to the navigation device in step 1050 is displayed on the display 240 and a user input is received by the navigation device 710 to select one of the displayed parking areas. Once a parking area has been selected, in step 1070 route guidance from the current location of the navigation device 710 is provided to direct the user to the selected parking area. The method ends in step 1080.

In other embodiments, the method 1000 described with reference to FIG. 10 may be altered. For example, in step 1040 the server 720 may automatically select a parking area for which route guidance is to be provided. The server 720 may automatically select a parking area for which route guidance is to be provided by the navigation device 710 based upon the same criteria as the navigation device 710 in the embodiment described with reference to FIG. 10. In order to facilitate the selection by the server 710, the navigation device 710 may communicate relevant information, such as user-specified criteria e.g. information indicating that a nearest parking location is to be selected, to the server 720 in step 1030 in conjunction with the information indicating the location of the navigation device 710. Once selected by the server 720, information indicating the location of the parking area for which route guidance is to be provided is communicated to the navigation device 710 in step 1050 and step 1060 is omitted.

Referring to FIG. 11, an embodiment of a method 1100 of alerting a user to expiry of a parking-payment period by a portable navigation device will now be explained. As noted above, in some embodiments, temporal information relating to the parking area may be communicated to the navigation device 710 by the server 720. The method 1100 explained with reference to FIG. 11 alerts a user of the portable navigation device to expiry of one or more temporal periods related to the parking area. In some embodiments, the one or more alerts are based on a location of the portable navigation device in relation to the location of the parking area in which the user's vehicle is parked. The method 1100 begins in step 1110. In step 1120 temporal information is received from the server 720. As described above, the temporal information may be received in step 840 of the method 800 described with reference to FIG. 8. The temporal information relates to a parking area and may indicate the payment-period or maximum stay duration in the parking area. For example, the information may indicate that payment is made for each whole hour and/or that the maximum parking duration is, for example, two hours. In step 1130 the navigation device determines a time at which it will check its current location for issuing a parking alert to the user. The time at which the navigation device checks its current location is determined with reference to the received temporal information. In some embodiments, the alert is determined according to maximum stay information indicating the maximum parking duration in the parking area received by the navigation device 710. In one embodiment, the check is performed after 50% of the maximum stay duration has elapsed, although it will be realised that other durations or times may be selected as appropriate. In step 1140, the navigation device determines its current location at the time determined in step 1130. The current location of the navigation device 710 may be determined from received GPS signals. Based on the location determined in step 1140, in step 1150 one or more parking alert times are determined in step 1160. The parking alert times are times at which an alert should be provided to the user regarding the received temporal duration of the parking area and the current location of the navigation device. In one embodiment, if more than a predetermined amount of the remaining time e.g. 80% is required for the user to return to the parking area, based upon an estimated travelling speed and map data accessible by the navigation device 710, then the navigation device issues an alert to the user indicating that they should begin to return to the parking area. The alert may be in the form of an audible and/or visual output of the portable navigation device 710. However, if the distance between the current location of the navigation device 710 and the parking area is such that the user may travel to the parking area in less than the predetermined amount of the remaining time, then a further location-check time is determined at which the navigation device 710 checks its current location.

It will be apparent from the foregoing that the teachings of the present invention provide an arrangement whereby payment for parking is facilitated. In embodiments of the invention payment may be made automatically. In some embodiments of the invention payment for parking is simplified by use of a navigation device to accurately measure a parking duration.

It will also be appreciated that whilst various aspects and embodiments of the present invention have heretofore been described, the scope of the present invention is not limited to the particular arrangements set out herein and instead extends to encompass all arrangements, and modifications and alterations thereto, which fall within the scope of the appended claims.

For example, whilst embodiments described in the foregoing detailed description refer to GPS, it should be noted that the navigation device may utilise any kind of position sensing technology as an alternative to (or indeed in addition to) GPS. For example the navigation device may utilise using other global navigation satellite systems such as the European Galileo system. Equally, it is not limited to satellite based but could readily function using ground based beacons or any other kind of system that enables the device to determine its geographic location.

It will also be well understood by persons of ordinary skill in the art that whilst the preferred embodiment implements certain functionality by means of software, that functionality could equally be implemented solely in hardware (for example by means of one or more ASICs (application specific integrated circuit)) or indeed by a mix of hardware and software. As such, the scope of the present invention should not be interpreted as being limited only to being implemented in software.

Lastly, it should also be noted that whilst the accompanying claims set out particular combinations of features described herein, the scope of the present invention is not limited to the particular combinations hereafter claimed, but instead extends to encompass any combination of features or embodiments herein disclosed irrespective of whether or not that particular combination has been specifically enumerated in the accompanying claims at this time.

1. A navigation device arranged to communicate information to a server is arranged to determine a period of time for which a vehicle carrying the navigation device is parked, and arranged to communicate information to the server associated with the period of time.

2. The navigation device of claim 1, wherein the navigation device is arranged to determine that the vehicle is parked according to one or more of: a location of the navigation device and receiving a user input indicating that the vehicle is parked.

3. The navigation device of claim 2, wherein the navigation device is arranged to determine that the vehicle is parked according to the location of the vehicle when the location of the vehicle does not substantially change for more than a predetermined period of time.

4. The navigation device according to claim 1, wherein the navigation device is arranged to communicate information to the server indicating a beginning and an end of the period for which the vehicle is parked.

5. The navigation device of claim 1, wherein the navigation device is arranged to determine that parking-payment is supported in a location at which the vehicle is parked according to stored data or by communication with the server.

6. The navigation device of claim 5, wherein the stored data is one of: data indicating a location of one or more parking locations received from the server or map data.

7. A method of facilitating payment for a service, the method comprising:
determining a period of time during which a vehicle carrying a navigation device is parked;
communicating information associated with the period of time from the navigation device to the server; and
facilitating payment for the period of time which the vehicle is parked.

8. The method of claim 7, comprising determining whether payment is supported in a parking location.

9. The method of claim 7, comprising receiving information at the navigation device from the server indicating one or more parking locations.

10. The method of claim 7, comprising:
communicating from the navigation device to the server information indicating a start of the period of time during which the vehicle is parked;
communicating from the navigation device to the server information indicating an end of the period of during which the vehicle is parked; and
determining at the sever a duration of the period of time during which the vehicle is parked, wherein the payment for the period of time is at least partly based on the determined duration.

11. The method of claim 7, comprising:
determining one or both of a start and an of the period of time during which the vehicle is parked according to at least one of a location of the navigation device and an input received from the user.

12. A system, comprising:
a navigation device in wireless communication with a server;
wherein the navigation device is arranged to communicate information to the server associated with a period of time during which a vehicle carrying the navigation device is parked; and
the server is arranged to facilitate payment for the period of time for which the vehicle is parked.

13. The system of claim 12, wherein the navigation device is arranged to:
determine when the vehicle parks and to communicate to the server information indicating a beginning of the period of time during which the vehicle is parked; and
determine when the vehicle ceases to be parked and to communicate to the server information indicating an end of the period of time during which the vehicle is parked.

14. The system of claim 12, wherein:
the navigation device is arranged to communicate to the server information indicative of a location; and
the server is arranged to communicate to the navigation device information indicative of one or more parking locations determined according to the received location.

15. The system of claim 12, wherein:
the navigation device is arranged to communicate to the server information indicative of a location; and
the server is arranged to communicate information to the navigation device indicative of whether the server is able to facilitate payment at the location.
